(19) United States
(12) Patent Application Publication
(10) Pub. No.: US 2005/0259095 A1
(43) Pub. Date: Nov. 24, 2005

(54) Display device, display panel, driving method thereof and deposition mask

(76) Inventor: Won-Kyu Kwak, Suwon-si (KR)

Correspondence Address: CHRISTIE, PARKER & HALE, LLP, PO BOX 7068, PASADENA, CA, 91109-7068, US

(21) Appl. No.: 11/126,886

(22) Filed: May 10, 2005

(30) Foreign Application Priority Data
May 21, 2004 (KR) 10-2004-0036298

(51) Int. Cl. G09G 5/00; G02F 1/1343

(52) U.S. Cl. 345/204

(57) ABSTRACT

A display device having a display area in which a plurality of pixel circuits are formed. The display area is divided into a plurality of first pixel groups, each comprising some of the plurality of pixel circuits. Each of the first pixel groups is divided into a plurality of second pixel groups, each comprising at least one of the pixel circuits. The plurality of second pixel groups of at least one of the first pixel groups respectively emit different color lights in a first subfield. The plurality of second pixel groups of the at least one of the first pixel groups respectively emit different color lights in a second subfield. The color of light emitted by at least one of the second pixel groups during the first subfield is different from the color of light emitted by the at least one of the second pixel groups during the second subfield.

### CROSS REFERENCE TO RELATED APPLICATION

This application claims priority to and the benefit of Korean Patent Application No. 10-2004-0036298 filed on May 21, 2004 in the Korean Intellectual Property Office, the entire content of which is incorporated herein by reference.

### BACKGROUND OF THE INVENTION

(a) Field of the Invention

The present invention relates to a display device, display panel, driving method thereof, and a deposition mask. More specifically, the present invention relates to an organic light emitting diode (OLED) display using electroluminescence of organic matter.

(b) Description of the Related Art

In general, an OLED display electrically excites a phosphorous organic compound to emit light, and it voltage- or current-drives n×m organic emitting cells to display images. The organic emitting cell includes an anode, an organic thin film, and a cathode layer. The organic thin film is made of a multiple structure including an emitting layer (EML), an electron transport layer (ETL), and a hole transport layer (HTL) to improve a balance of an electron and a hole for an emission efficiency. Further, the organic thin film may include an electron injecting layer (EIL), and a hole injecting layer (HIL).

Methods for driving the organic emission cells include a passive matrix method, and an active matrix method using thin film transistors (TFTs). The passive matrix method provides anodes and cathodes that cross (or cross over) each other, and selects a line to drive the organic emission cells. The active matrix method provides TFTs that are coupled to respective pixel electrodes, and drives a pixel according to a voltage maintained by a capacitance of a capacitor coupled to a gate of a TFT. Here, depending on formats of signals applied to the capacitor for establishing the voltage, the active matrix method can be categorized as a voltage programming method and a current programming method.

In the OLED display, a pixel includes a plurality of sub-pixels each of which has one of a plurality colors (e.g., primary colors of light), and colors are represented through combinations of the colors emitted by the sub-pixels. In general, a pixel includes a sub-pixel for displaying red R, a sub-pixel for displaying green G, and a sub-pixel for displaying blue B, and the colors are displayed by combinations of red, green, and blue (RGB).

Hereinafter, an OLED display according to the voltage programming method and the current programming method are described with reference to FIG. 1 and FIG. 2.

FIG. 1 and FIG. 2 respectively indicate one pixel of the n×m pixels which is located at a first column and a first row, according to a conventional voltage programming method and a conventional current programming method. Further, the pixel circuits of FIG. 1 and FIG. 2 include p-channel transistors.

As shown in FIG. 1, a pixel 10 includes three subpixels 10r, 10g and 10b. The subpixels 10r, 10g and 10b respectively have OLED elements OLEDr, OLEDg, and OLEDb, which respectively emit a red color light (R), a green color light (G), and a blue color light (B). The subpixels 10r, 10g and 10b are respectively coupled to separated data line (D1r, D1g, and D1b) and a common selection scan line (S1) as shown in FIG. 1. Similarly, as shown in FIG. 2, a pixel 10′ includes three subpixels 10r′, 10g′ and 10b′. The subpixels 10r′, 10g′ and 10b′ respectively have OLED elements OLEDr′, OLEDg′, and OLEDb′, which respectively emit a red color light (R), a green color light (G), and a blue color light (B). The subpixels 10r′, 10g′ and 10b′ are respectively coupled to separated data line (D1r′, D1g′, and D1b′) and a common selection scan line (S1′) as shown in FIG. 2.

First, a pixel of an OLED display according to the voltage programming method is described with reference to FIG. 1.

As shown in FIG. 1, a red subpixel 10r includes two transistors M1r and M2r, and a capacitor C1r to drive an OLED element OLEDr. A green subpixel 10g includes two transistors M1g and M2g, and a capacitor C1g to drive an OLED element OLEDg. A blue subpixel 10b includes two transistors M1b and M2b, and a capacitor C1b to drive an OLED element OLEDb. Operations of these subpixels 10r, 10g and 10b are substantially the same, thus the operation of one subpixel 10r will be described only.

The driving transistor M1r is coupled between a supply voltage (VDD) and the OLED element OLEDr and applies a current for emission to the OLED element OLEDr. A cathode of the OLED element OLEDr is coupled to a voltage (VSS) which is lower than the supply voltage (VDD). The magnitude of the current provided by the driving transistor M1r may be controlled by a data voltage applied through the switching transistor M2r. The capacitor C1r for maintaining the applied voltage for a predetermined time is coupled between a source and a gate of the transistor M1r. A gate of the transistor M2r is coupled to a selection scan line S1 for transferring a on/off select signal, and a source of the transistor M2r is coupled to a data line D1r for transferring a data voltage corresponding to the red subpixel 10r.

In operation, when the switching transistor M2r is turned on in response to the select signal applied to the gate, the data voltage V_{DATA} provided from the data line D1r is applied to the gate of the transistor M1r to charge the capacitor C1r with the voltage V_{GS} between the gate and the source, a current I_{OLED} flows though the transistor M1r in response to the charged voltage V_{GS}, and the OLEDr emits light in response to the current I_{OLED}. The current flowing through the OLEDr is given as Equation 1.

$${I}_{OLED} = \frac{β}{2} {( {V}_{GS} - {V}_{TH} )}^{2} = \frac{β}{2} {( {V}_{DD} - {V}_{DATA} - \vert {V}_{TH} \vert )}^{2} \qquad Equation 1$$

where V_{TH} is a threshold voltage of the transistor M1r, and β is a constant.

As given in Equation 1, the current corresponding to the data voltage is supplied to the OLEDr, and the OLEDr emits light in response to the supplied current. The applied data voltage has multiple-stage values within a predetermined range so as to represent gray scales.

Next, a pixel of an OLED display according to the current programming method is described with reference to FIG. 2. As shown in FIG. 2, the subpixels 10r′, 10g′ and 10b′ in the OLED display according to the current programming method respectively further include transistors M3r′, M3g′, M3b′ for controlling light emission, and transistors M4r′, M4g′, M4b′ for diode connecting, in addition to the driving transistors and the switching transistors. The transistors M3r′, M3g′, M3b′ are turned on in response to a control signal provided from an emission control scan line E1. Operations of these subpixels 10r′, 10g′ and 10b′ are the same, thus the operation of one subpixel 10r′ will be described only.

In operation of the circuit, when the transistors M2r′ and M4r′ are turned on, the driving transistor M1r′ is diode connected. Then, a data current is applied and charged to the capacitor C1r′, the gate voltage potential of the transistor M1r′ is lowered, and the current flows from a source to a drain of the transistor M1r′. When the voltage charged in the capacitor C1r′ is increased, and the drain current of the transistor M1r′ grows to be substantially the same as a drain current of the transistor M2r′, then charging to the capacitor C1r′ is stopped and the voltage charged in the capacitor C1r′ is stabilized.

Thus, the voltage corresponding to the data current (I_{data}) provided by a data line (D1r′) is charged in the capacitor C1r′. Next, a select signal provided by the selection scan line (S1′) is switched to a high level, and the transistors M2r′ and M4r′ are turned off. Further, a control signal provided by the emission scan line (E1′) is switched to a low level. Then, the transistor M3r′ is turned on. Then, the voltage is supplied from the supply voltage VDD, and a current corresponding to the voltage charged in the capacitor C1r′ is applied to the OLED element OLEDr. The OLED element OLEDr emits light according to a predetermined brightness. The current (I_{OLED}) applied to the OLED element (OLEDr) can be given in Equation 2.

$${I}_{OLED} = \frac{β}{2} {( {V}_{GS} - {V}_{TH} )}^{2} = {I}_{data} \qquad Equation 2$$

where V_{GS} is a voltage between the gate and the source of transistor M1r′, V_{TH} is a threshold voltage at transistor M1r′, and β is a constant.

As described above, in a conventional OLED display, each pixel 10 (or 10′) includes three subpixels 10r, 10g and 10b (or 10r′, 10g′ and 10b′), each sub-pixel includes a driving transistor for driving an OLED element, a switching transistor, and a capacitor. Also, each sub-pixel has a data line for transmitting a data signal, and a power line for transmitting a power supply voltage VDD. Therefore, many wires are required for transmitting voltages and/or signals to the transistors and capacitor formed at each pixel. It is difficult to arrange such wires in the pixel, and the aperture ratio corresponding to a light emission area of the pixel is reduced.

### SUMMARY OF THE INVENTION

It is an aspect of the present invention to improve the aperture ratio in a light emission display.

It is another aspect of the present invention to simplify an arrangement of elements and wires in a pixel.

In one exemplary embodiment of the present invention, a display device having a display area in which a plurality of pixel circuits are formed is provided. At least one of the pixel circuits includes: at least two emit elements for respectively emitting different color lights corresponding to an applied current, a transistor for providing an output current according to a data signal, and at least two first switches for respectively applying the output current provided by the transistor as the applied current to the at least two emit elements. The display area is divided into a plurality of first pixel groups, each including some of the pixel circuits, and each of the first pixel groups is divided into a plurality of second pixel groups, each including at least one of the pixel circuits. The plurality of second pixel groups of at least one of the first pixel groups respectively emit different color lights in a first subfield, and the plurality of second pixel groups of the at least one of the first pixel groups respectively emit different color lights in a second subfield. The color of light emitted by at least one of the second pixel groups during the first subfield is different from the color of light emitted by the at least one of the second pixel groups during the second subfield.

In another exemplary embodiment of the present invention, a display panel of a display device is provided. The display panel includes a display area for displaying an image corresponding to a magnitude of an applied current, in which a plurality of pixel circuits having at least two emit elements for respectively emitting different color images are formed. A plurality of first areas, each including some of the plurality of pixel circuits, are formed in the display area. A plurality of second areas, each including at least one of the pixel circuits, are formed in at least one of the first areas. Here, one field is divided into a plurality of subfields and then driven, and the plurality of second areas in the at least one of the first areas are configured to display different color images during one of the subfields.

In another exemplary embodiment of the present invention, a driving method of a display device having a display area in which a plurality of pixel circuits are formed is provided. At least one of the pixel circuits includes at least two emit elements for respectively emitting different color lights corresponding to an applied current, a capacitor for storing a voltage corresponding to the data signal in response to a select signal, and a transistor for providing a current corresponding to the voltage stored in the capacitor as the applied current. The display area is divided into a plurality of first areas, each including some of the pixel circuits, and at least one of the first areas is divided into a plurality of second areas, each including at least one of the pixel circuits. The driving method includes in one frame, a first stage for emitting different color lights in the plurality of second areas in at least one of the first areas, and a second stage for emitting different color lights in the plurality of second areas in the at least one of the first areas. The color of the light emitted in at least one of the second areas during the first stage is different from the color of the light emitted in the at least one of the second areas during the second stage.

Here, a number of the second pixel areas emitting substantially the same color of light may be the same in the first stage. The second areas that are adjacent to each other along a row direction of the plurality of the second areas in the at least one of the first areas, may display different color lights during the first stage. The second areas that are adjacent to each other in a column direction of the plurality of the second areas in the at least one of the first areas may display different color lights during the first stage. The second areas that are adjacent to each other in a row direction of the plurality of second areas in the at least one of the first areas may display different color lights in the second stage, and the second areas that are adjacent to each other in a column direction of the plurality of second areas in the at least one of the first areas may display different color lights in the second stage.

In another exemplary embodiment of the present invention, a deposition mask for forming an emit layer defining a first color of an emit element in a display device in which a display area having a plurality of pixels, each having at least two emit elements having different colors, is formed, is provided. The deposition mask includes a plurality of first areas, each of the first areas corresponding to one of a plurality of pixel groups the display area is divided into. At least one of the first areas is divided into a plurality of second areas, each having at least one of the pixels. The at least one of the first areas also includes a plurality of apertures which are respectively formed at third areas corresponding to the first color of emit elements of the plurality of pixels. The third areas are differently arranged in two different ones of the second areas of at least one of the first areas.

### BRIEF DESCRIPTION OF THE DRAWINGS

The accompanying drawings illustrate exemplary embodiments of the present invention, and, together with the description, serve to explain the principles of the present invention:

FIG. 1 shows a pixel in an OLED display according to a conventional voltage programming method;

FIG. 2 shows a pixel in an OLED display according to a conventional current programming method;

FIG. 3 shows a simplified plan view of a light emission display device that can represent any of various exemplary embodiments of the present invention;

FIG. 4 shows a conceptual diagram of a pixel in the OLED display of FIG. 3;

FIG. 5 shows a circuit diagram of a pixel in an OLED display according to a first exemplary embodiment of the present invention;

FIG. 6 shows a signal timing diagram of the OLED display according to the first exemplary embodiment of the present invention;

FIG. 7 shows a display panel which is divided into a plurality of pixel areas according to a second exemplary embodiment of the present invention;

FIG. 8 shows an image displayed in one pixel area of the plurality of pixel areas shown in FIG. 7;

FIG. 9 shows a pixel formed at the pixel area according to the second exemplary embodiment of the present invention;

FIG. 10 shows a pixel formed at a pixel area according to a third exemplary embodiment of the present invention;

FIG. 11A to FIG. 11C respectively show a part of a deposition mask for forming red, green and blue OLED elements on a display panel for a light emission display according to the third exemplary embodiment of the present invention.

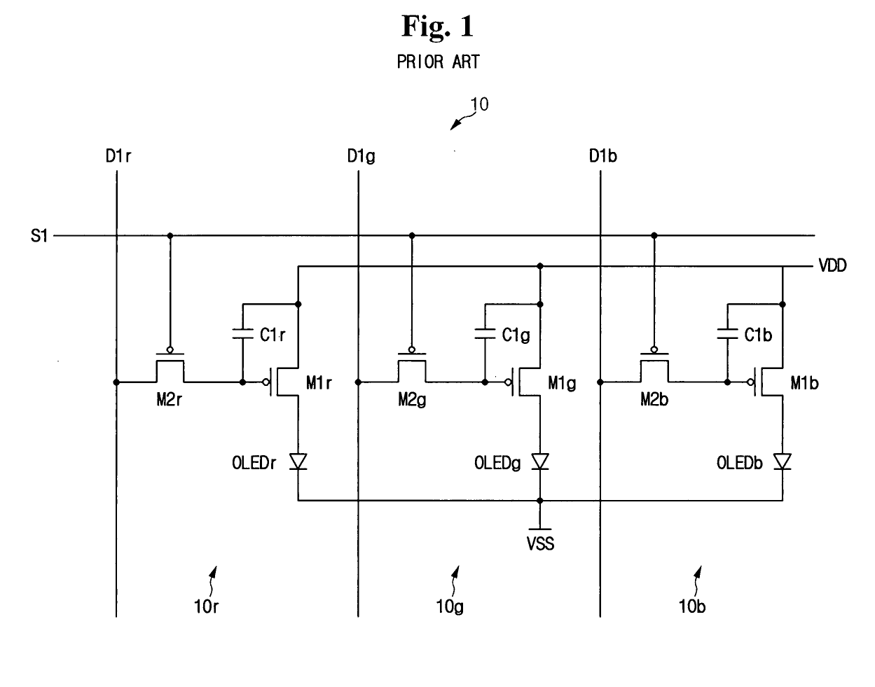

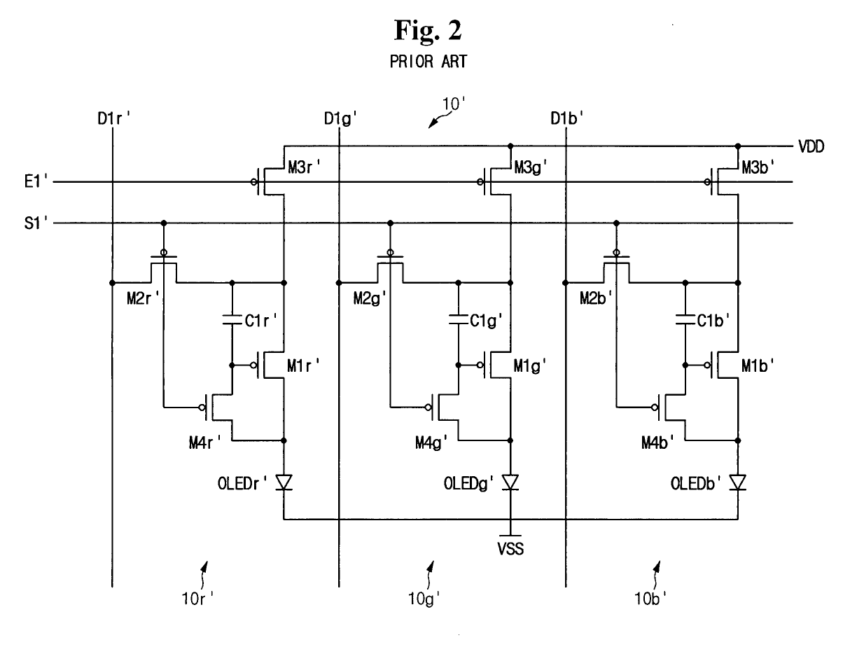

### DETAILED DESCRIPTION

In the following detailed description, only certain exemplary embodiments of the present invention are shown and described, simply by way of illustration. As those skilled in the art would realize, the described embodiments may be modified in various different ways, all without departing from the spirit or scope of the present invention. Accordingly, the drawings and description are to be regarded as illustrative in nature, and not restrictive.

There may be parts shown in the drawings, or parts not shown in the drawings, that are not discussed in the specification as they are not essential to a complete understanding of the invention. Like reference numerals designate like elements.

A light emission display and driving method thereof according to exemplary embodiments of the present invention will be described in detail with reference to the drawings, and an OLED display according to the exemplary embodiments will be described.

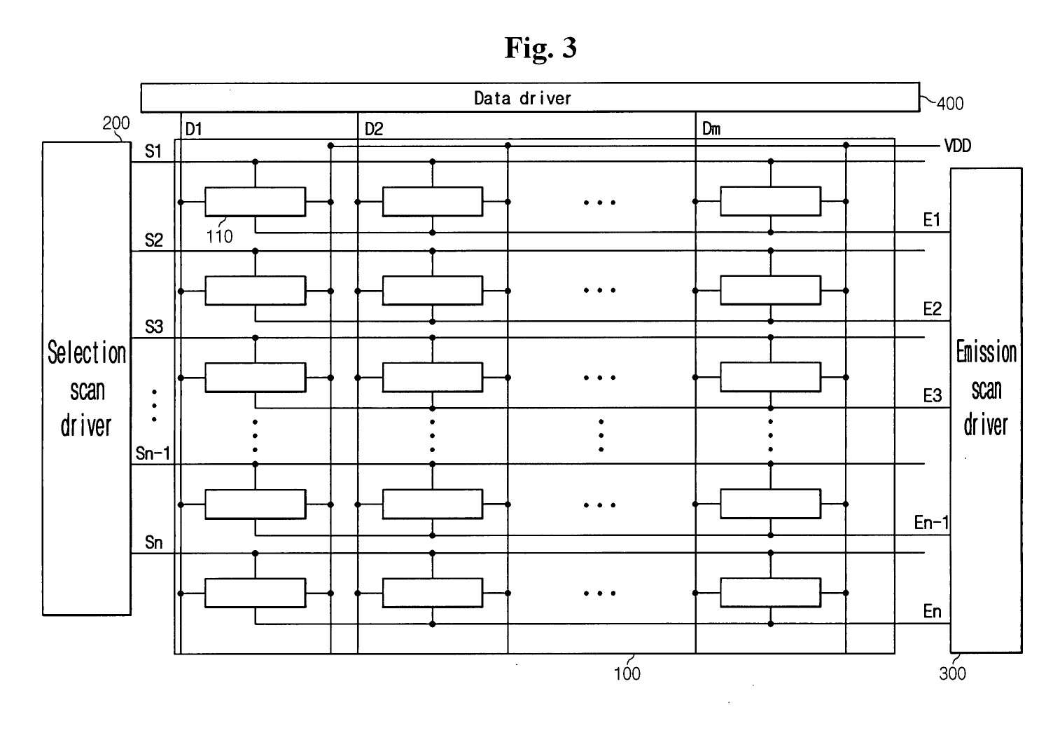

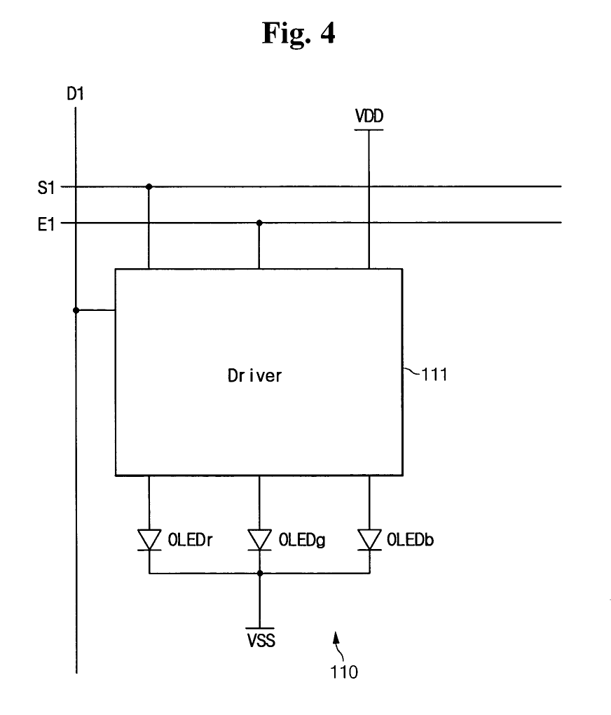

FIG. 3 shows a plan view of an OLED display according to a first exemplary embodiment of the present invention, and FIG. 4 shows a conceptual diagram of a pixel in the OLED display of FIG. 3.

As shown in FIG. 3, the OLED display according to the first exemplary embodiment includes a display panel 100, a selection scan driver 200, an emission scan driver 300, and a data driver 400. The display panel 100 includes a plurality of scan lines S1 to Sn and E1 to En arranged in the row direction, and a plurality of data lines D1 to Dm, a plurality of power lines VDD, and a plurality of pixels 110 respectively arranged in the column direction. The pixels are formed at pixel areas defined by two adjacent ones of the scan lines S1 to Sn and two adjacent ones of the data lines D1 to Dm. Referring to FIG. 4, the pixel 110 includes OLED elements OLEDr, OLEDg, and OLEDb for emitting red, green, and blue lights, respectively, and a driver 111 in which elements for driving the OLED elements OLEDr, OLEDg, and OLEDb are formed. The OLED elements emit light having brightness corresponding to the applied current.

Referring back to FIG. 3, the selection scan driver 200 sequentially applies select signals to the plurality of scan lines S1 to Sn in order to apply data signals to pixels coupled to the corresponding scan lines, and the emission scan driver 300 sequentially applies emit signals for controlling light emission of the OLED elements OLEDr, OLEDg, and OLEDb to the emission scan lines E1 to En. The data driver 400 applies data signals corresponding to the pixels of lines to which select signals are applied, to the data lines D1 to Dm, each time the select signals are sequentially applied.

The select and emission scan drivers 200 and 300 and the data driver 400 are electronically coupled to a substrate on which the display panel 100 is formed. However, the select and emission scan drivers 200 and 300 and/or the data driver 400 can be installed directly on the substrate of the display 100, and they can be substituted with a driving circuit which is formed on the same layer on the substrate of the display 100 as the layer on which scan lines, data lines, and transistors are formed. Further, the select and emission scan drivers 200 and 300 and/or the data driver 400 can be installed in a chip format on a tape carrier package (TCP), a flexible printed circuit (FPC), or a tape automatic bonding unit (TAB) coupled to the select and emission scan drivers 200 and 300 and/or the data driver 400.

Here, one field is divided into three subfields and then driven, and red, green, and blue data are written on the three subfields to emit light in the first exemplary embodiment. For this purpose, the selection scan driver 200 sequentially transmits select signals to the selection scan lines S1 to Sn for each subfield, the emission scan driver 300 applies emit signals to the emission scan lines E1 to En so that the OLED element for each color may emit light in a subfield, and the data driver 400 applies data signals respectively corresponding to the red, green, and blue OLED elements to the data lines D1 to Dm.

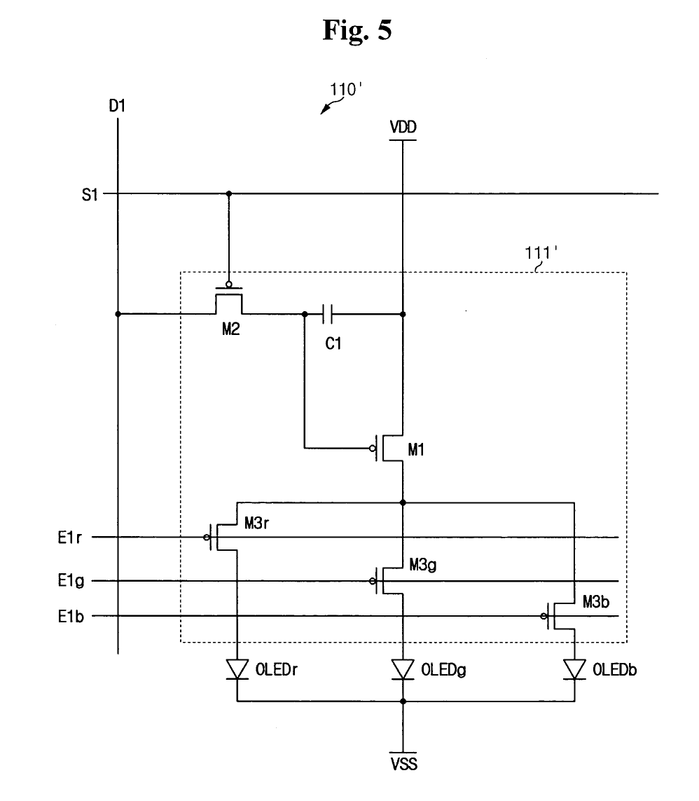

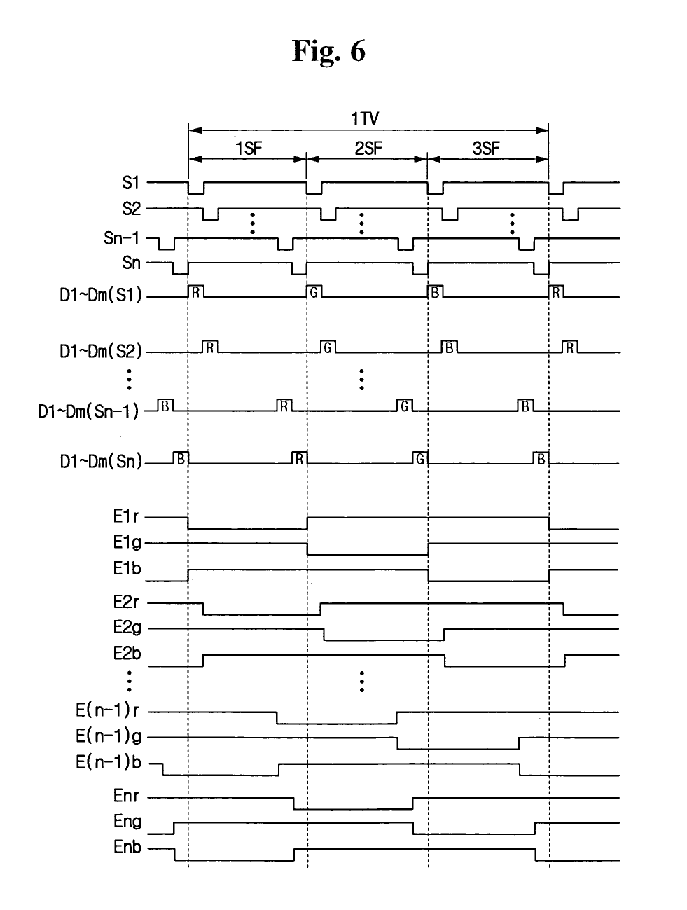

Hereinafter, a detailed operation of the OLED display according to a first exemplary embodiment will be described with reference to FIGS. 5 and 6.

FIG. 5 shows a circuit diagram of a pixel 110′ in the OLED display according to the first exemplary embodiment of the present invention, and FIG. 6 shows a signal timing diagram of the OLED display according to the first exemplary embodiment of the present invention. FIG. 5 shows the pixel 110′ according to a voltage programming method, which is coupled to a selection scan line S1 and a data line D1. As shown in FIG. 5, the pixel 110′ has p-channel transistors, as will be described below. Only one of the pixels 110′ in the OLED display will be described in reference to FIG. 5 since the pixels of the first exemplary embodiment have substantially the same structure as that shown in FIG. 5.

As shown in FIG. 5, the pixel circuit 110′ according to the first exemplary embodiment of the present invention includes a driving transistor M1, a switching transistor M2, three OLED elements OLEDr, OLEDg, and OLEDb, and emitting transistors M3r, M3g, and M3b for controlling light emission of the OLED elements OLEDr, OLEDg, and OLEDb. One emission scan line E1 includes three emit signal lines E1r, E1g, and E1b, and while not illustrated in FIG. 5, other emission scan lines E2 to En respectively include three emit signal lines E2r to Enr, E2g to Eng, and E2b to Enb. The emitting transistors M3r, M3b, and M3b and the emit signal lines E1r, E1g, and E1b form a switch for selectively transmitting the current provided by the driving transistor M1 to the OLED elements OLEDr, OLEDg, and OLEDb.

In detail, the switching transistor M2 having a gate coupled to the selection scan line S1 and a source coupled to the data line D1 transmits the data voltage provided by the data line D1 in response to the select signal provided by the selection scan line S1. The driving transistor M1 has a source coupled to the power supply line for supplying a power supply voltage VDD, and has a gate coupled to a drain of the switching transistor M2, and a capacitor C1 is coupled between a source and the gate of the driving transistor M1. The driving transistor M1 has a drain coupled to sources of the emit transistors M3r, M3g, and M3b, and gates of the emit transistors M3r, M3g, and M3b are coupled to the emit signal lines E1r, E1g, and E1b, respectively. Drains of the emit transistors M3r, M3g, and M3b are coupled, respectively, to anodes of the OLED elements OLEDr, OLEDg, and OLEDb, and a power supply voltage VSS is applied to cathodes of the OLED elements OLEDr, OLEDg, and OLEDb. The power supply voltage VSS in the first exemplary embodiment can be a negative voltage or a ground voltage.

The switching transistor M2 transmits the data voltage provided by the data line D1 to the gate of the driving transistor M1 in response to a low-level select signal provided by the selection scan line S1, and the voltage which corresponds to a difference between the data voltage transmitted to the gate of the transistor M1 and the power supply voltage VDD is stored in the capacitor C1. When the emitting transistor M3r is turned on in response to a low-level emit signal provided by the emit signal line E1r, the current which corresponds to the voltage stored in the capacitor C1 is transmitted to the red OLED element OLEDr from the driving transistor M1 to emit light.

Similarly, when the emitting transistor M3g is turned on in response to a low-level emit signal provided by the emit signal line E1g, the current which corresponds to the voltage stored in the capacitor C1 is transmitted to the green OLED element OLEDg from the driving transistor M1 to emit light.

Further, when the emitting transistor M3b is turned on in response to a low-level emit signal provided by the emit signal line E1b, the current which corresponds to the voltage stored in the capacitor C1 is transmitted to the blue OLED element OLEDb from the driving transistor M1 to emit light.

Three emit signals applied to the three emit signal lines respectively have low-level periods without repetition during one field so that one pixel can display red, green, and blue.

Hereinafter, a driving method of an OLED display will be described in detail with reference to FIG. 6. In FIG. 6, one field 1TV includes three subfields 1SF, 2SF, and 3SF, and signals for driving the red, green, and blue OLED elements are applied in the subfields 1SF, 2SF, and 3SF. The subfields 1SF, 2SF and 3SF have substantially the same duration or period.

In the subfield 1SF, when a low-level select signal is applied to the selection scan line S1 on the first row, data voltages of R corresponding to red of the pixels on the first row are applied, respectively, to the data lines D1 to Dm. A low-level emit signal is applied to the emit signal line E1r on the first row. Then, the data voltage R is applied to the capacitor C1 through the switching transistor M2 of each pixel on the first row, and a voltage corresponding to the data voltage R is charged in the capacitor C1. The emitting transistor M3r of the pixel on the first row is turned on, and a current corresponding to a gate-source voltage stored in the capacitor C1 is transmitted to the red OLED element OLEDr from the driving transistor M1 to thus emit light.

Next, when a low-level select signal is applied to the selection scan line S2 on the second row, the data voltage R corresponding to the red of pixels of the second row are applied, respectively, to the data lines D1 to Dm, a low-level emit signal is applied to the emit signal line E2r of the second row, and a current corresponding to the corresponding one of the data voltages of R provided by a corresponding one of the data lines D1 to Dm is supplied to the red OLED element OLEDr of each pixel on the second row to thus emit light.

Then the data voltages are sequentially applied to pixels of from the third to (n−1)th rows to emit the red OLED element OLEDr. When a low-level select signal is applied to the selection scan line Sn on the nth row, the data voltage R corresponding to the red of the pixels of the nth row are applied to the data lines D1 to Dm, and a low-level emit signal is applied to the emit signal line Enr of the nth row. Then, a current corresponding to a corresponding one of the data voltages of R provided by the data lines D1 to Dm is accordingly supplied to the red OLED element OLEDr of each pixel on the nth row to thus emit light.

As a result, the data voltage R corresponding to red is applied to the respective pixels formed on the display panel 100 during the subfield 1SF. The emit signals applied to the emit signal lines E1r to Enr are maintained at the low level for a predetermined time, and the OLED element OLEDr coupled to the emitting transistor M3r to which the corresponding low-level emit signal is applied, consecutively emits light. This period is illustrated to correspond to the subfield 1SF in FIG. 6. That is, the red OLED element OLEDr for each pixel emits light with brightness which corresponds to the data voltage applied during the period which corresponds to the subfield 1SF.

In the next subfield 2SF, in a like manner as the subfield 1SF, a low-level select signal is sequentially applied to the selection scan lines S1 to Sn of from the first to the nth rows, and when the select signal is applied to the respective selection scan lines S1 to Sn, data voltage G corresponding to green of pixels of the corresponding rows are applied, respectively, to the data lines D1 to Dm. A low-level emit signal is sequentially applied to the emit signal lines E1g to Eng in synchronization with sequentially applying the low-level select signal to the selection scan lines S1 to Sn. A current corresponding to the applied data voltage is transmitted to the green OLED element OLEDg through the emitting transistor M3g in each pixel to emit light.

The emit signals applied to the emit signal lines E1g to Eng are maintained at the low level for a predetermined time, and the OLED element OLEDg coupled to the emitting transistor M3g to which the corresponding low-level emit signal is applied, consecutively emits light. This period is illustrated to correspond to the subfield 2SF in FIG. 6. That is, the green OLED element OLEDg for each pixel emits light with brightness which corresponds to the data voltage applied during the period which corresponds to the subfield 2SF.

In the subfield 3SF, in a like manner as the subfield 1SF, a low-level select signal is sequentially applied to the selection scan lines S1 to Sn of from the first to the nth rows, and when the select signal is applied to the respective selection scan lines S1 to Sn, data voltage B corresponding to blue of pixels of the corresponding rows are applied, respectively, to the data lines D1 to Dm. A low-level emit signal is sequentially applied to the emit signal lines E1b to Enb in synchronization with sequentially applying the low-level select signal to the selection scan lines S1 to Sn. A current corresponding to the applied data voltage of B is transmitted to the blue OLED element OLEDb through the emitting transistor M3b in each pixel to emit light.

The emit signals applied to the emit signal lines E1b to Enb are maintained at the low level for a predetermined time, and the OLED element OLEDb coupled to the emitting transistor M3b to which the corresponding low-level emit signal is applied, consecutively emits light. This period is illustrated to correspond to the subfield 3SF in FIG. 6. That is, the blue OLED element OLEDb for each pixel emits light with brightness which corresponds to the data voltage applied during the period which corresponds to the subfield 3SF.

As described above, one field is divided into three subfields, and the subfields are sequentially driven in the OLED display driving method according to the first exemplary embodiment. One color OLED element of one pixel in each subfield emits light, and the OLED elements of three colors (red, green, and blue) sequentially emit light through three subfields to thus represent colors.

The signal timing diagram of FIG. 6 illustrates that the OLED display is driven from the single scan method to the progressive scan method. In addition, the OLED display can be driven using a dual scan method, an interlaced scan method, and/or other scan methods without being restricted to them.

Further, the voltage programming pixel circuit using switching transistors and driving transistors has been described in the first exemplary embodiment. In addition, the signal timing diagram of FIG. 6 can also be applied to a voltage programming pixel circuit using transistors for compensating for threshold voltages of the driving transistors or transistors for compensating for voltage dropping as well as the switching transistors and driving transistors.

The OLED elements sequentially emit light of one color in one subfield, and other OLED elements sequentially emit light of other colors in the next subfield in the first exemplary embodiments. The color emitted at upper rows of the display panel is different from the color emitted at lower rows thereof at an instance during the above-noted driving. Referring to FIG. 6, the red OLED elements emit light in the upper region of the display area and the blue OLED elements emit light in the lower region of the display area in the temporally middle part of one subfield 1SF. When the OLED display is shaken in this instance, red areas and blue areas may look separated, which is generally referred to as a color separation phenomenon.

Thus, in a second exemplary embodiment, a display panel 200 is divided into a plurality of pixel areas 220 and the same number of red, green and blue OLED elements OLEDr, OLEDg, and OLEDb are emitted for each subfield in each pixel area. The OLED elements OLEDr, OLEDg, and OLEDb for emitting red, green and blue lights respectively are emitted according to different order at each time subfield is changed, to reduce or eliminate the color separation phenomenon

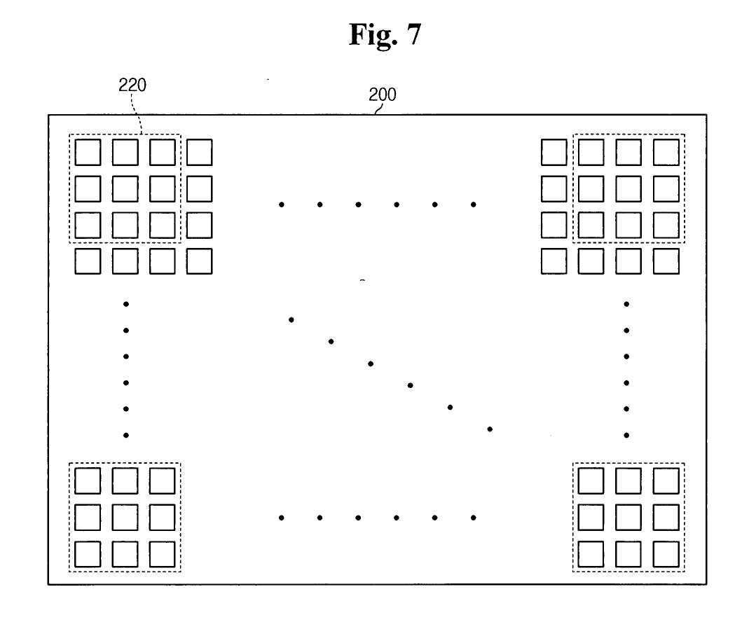

The second exemplary embodiment of the present invention is described in detail with reference to FIGS. 7, 8 and 9.

FIG. 7 shows the display panel 200 which is divided into a plurality of pixel areas according to the second exemplary embodiment of the present invention. For ease of description, one pixel area 220 including 3×3 of 9 pixels will be described in reference to FIG. 7. The display panel 200 has substantially the same structural configuration as the display panel 100 of FIG. 3, but the pixels in each pixel area 220 can have different configurations.

As such, one display panel is divided into a plurality of pixel areas, and pixel circuits are formed at each pixel area, such that the same number of red, green and blue OLED elements OLEDr, OLEDg, and OLEDb are emitted for each subfield in each pixel area.

The number of the pixel circuits included in each pixel area is shown to be the same in FIG. 7, however the number of the pixel circuits included in each pixel area may be different according to other exemplary embodiments. When each pixel circuit displays three colors, the number of the pixel circuits formed in each pixel area should be a multiple of three.

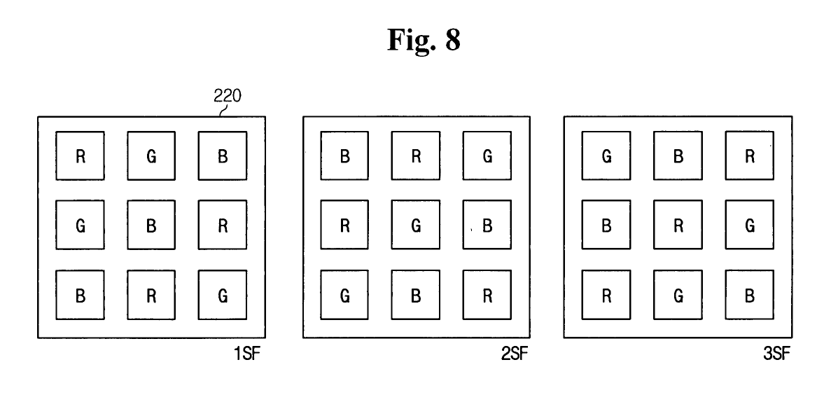

FIG. 8 shows an image displayed in one pixel area 220 of the plurality of pixel areas shown in FIG. 7.

As shown in FIG. 8, in a first subfield 1SF, red, green and blue OLED elements OLEDr, OLEDg and OLEDb are respectively emitted in the pixel circuits in a first row, the green, blue and red OLED elements OLEDg, OLEDb and OLEDr are respectively emitted in the pixel circuits in a second row, and the blue, red and green OLED elements OLEDb, OLEDr and OLEDg are respectively emitted in the pixel circuits in a third row. FIG. 8 also shows the emission of the red, green and blue OLED elements in the pixel circuits in the first, second and third rows during subfields 2SF and 3SF.

Further, in the first subfield, 1SF, of the pixel circuits formed in the pixel area 220, the pixel circuits formed in a first column emit light in the order of red, green and blue OLED elements OLEDr, OLEDg and OLEDb. In addition, the pixel circuits formed in a second column emit light in the order of green, blue and red OLED elements OLEDg, OLEDb and OLEDr. Further, the pixel circuits formed in a third column emit light in the order of blue, red and green OLED elements OLEDb, OLEDr and OLEDg. FIG. 8 also shows the emission of the red, green and blue OLED elements in the pixel circuits in the first, second and third columns during the subfields 2SF and 3SF.

As such, three colors are mixed and emitted in the pixel circuits provided on the same row, and three colors are mixed and emitted in the pixel circuits provided on the same column at each subfield. As a result, since the three colors are mixed and emitted in the row direction and the column direction at all pixel areas, the color separation phenomenon which may be caused because of different colors on the upper region and lower region of the screen is reduced or eliminated.

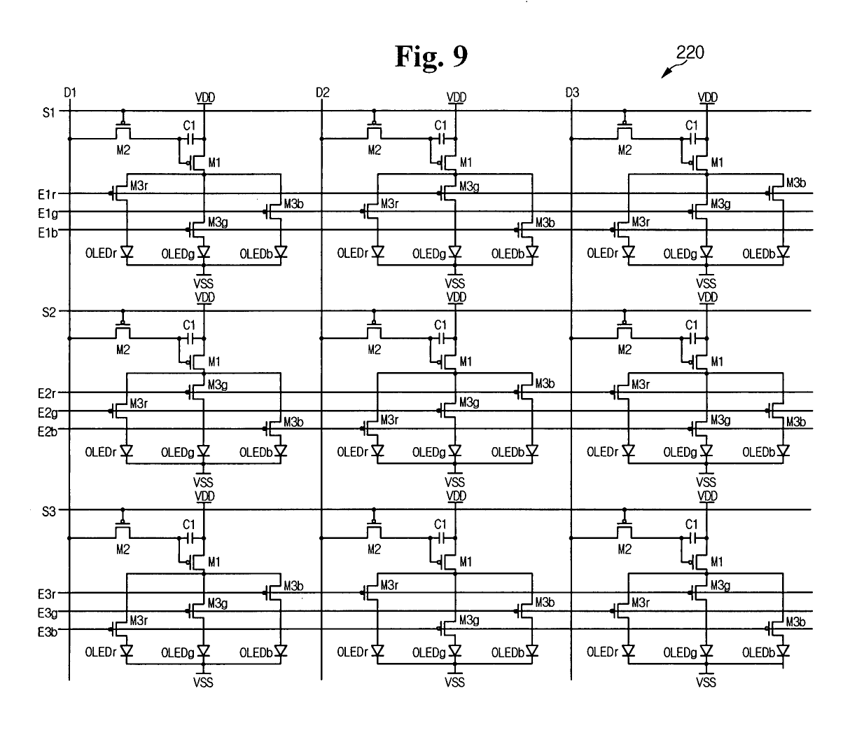

FIG. 9 shows 9 pixel circuits included in the pixel area 220 of FIG. 8. In FIG. 9, the pixel area 220 of FIG. 8 is defined by scan lines (S1 to S3) and data lines (D1 to D3).

Referring to FIG. 9, in the three pixel circuits coupled to the scan line S1, gates of a transistor M3r of the pixel circuit coupled to the data line D1, a transistor M3g of the pixel circuit coupled to the data line D2, and a transistor M3b of the pixel circuit coupled to the data line D3 are coupled to an emit signal line E1r. In a like manner, gates of a transistor M3b of the pixel circuit coupled to the data line D1, a transistor M3r of the pixel circuit coupled to the data line D2, and a transistor M3g of the pixel circuit coupled to the data line D3 are coupled to an emit signal line E1g. Also, gates of a transistor M3g of the pixel circuit coupled to the data line D1, a transistor M3b of the pixel circuit coupled to the data line D2, and a transistor M3r of the pixel circuit coupled to the data line D3 are coupled to an emit signal line E1b.

In the three pixel circuits coupled to the scan line S2, gates of a transistor M3g of the pixel circuit coupled to the data line D1, a transistor M3b of the pixel circuit coupled to the data line D2, and a transistor M3r of the pixel circuit coupled to the data line D3 are coupled to an emit signal line E2r. In a like manner, gates of a transistor M3r of the pixel circuit coupled to the data line D1, a transistor M3g of the pixel circuit coupled to the data line D2, and a transistor M3b of the pixel circuit coupled to the data line D3 are coupled to an emit signal line E2g. Also, gates of a transistor M3b of the pixel circuit coupled to the data line D1, a transistor M3r of the pixel circuit coupled to the data line D2, and a transistor M3g of the pixel circuit coupled to the data line D3 are coupled to an emit signal line E2b.

In the three pixel circuits coupled to the scan line S3 on the third row, gates of a transistor M3b of the pixel circuit coupled to the data line D1, a transistor M3r of the pixel circuit coupled to the data line D2, and a transistor M3g of the pixel circuit coupled to the data line D3 are coupled to an emit signal line E3r. In a like manner, gates of a transistor M3g of the pixel circuit coupled to the data line D1, a transistor M3b of the pixel circuit coupled to the data line D2, and a transistor M3r of the pixel circuit coupled to the data line D3 are coupled to an emit signal line E3g. Also, gates of a transistor M3r of the pixel circuit coupled to the data line D1, a transistor M3g of the pixel circuit coupled to the data line D2, and a transistor M3b of the pixel circuit coupled to the data line D3 are coupled to an emit signal line E3b.

As such, the color separation phenomenon can be reduced or eliminated by forming the pixel areas 220, even though the driving method of the emit signal lines E1 to En shown in FIG. 6 can be applied.

Hereinafter, the driving method of a display panel according to the second exemplary embodiment of the present invention will be described.

In the subfield 1SF, when the select signal is applied to the scan line S1, data voltages R, G and B respectively corresponding to red, green and blue OLED elements OLEDr, OLEDg and OLEDb are respectively applied to the data lines D1, D2 and D3. Then, the emit signal is applied to the emit signal line E1r, and red, green and blue OLED elements OLEDr, OLEDg and OLEDb respectively emit light at three adjacent pixel circuits in the row direction.

When the select signal is applied to the scan line S2, data voltages G, B and R respectively corresponding to green, blue, and red OLED elements OLEDg, OLEDb and OLEDr are respectively applied to the data lines D1, D2 and D3. Then, the emit signal is applied to the emit signal line E2r, and green, blue and red OLED elements OLEDg, OLEDb and OLEDr respectively emit light at three adjacent pixel circuits in the row direction.

When the select signal is applied to the scan line S3, data voltages B, R and G respectively corresponding to blue, red, and green OLED elements OLEDb, OLEDr and OLEDg are respectively applied to the data lines D1, D2 and D3. Then, the emit signal is applied to the emit signal line E3r, and blue, red and green OLED elements OLEDb, OLEDr and OLEDg respectively emit light at three adjacent pixel circuits in the row direction.

In the subfield 2SF, when the select signal is applied to the scan line S1, data voltages B, R and G respectively corresponding to blue, red and green OLED elements OLEDb, OLEDr and OLEDg are respectively applied to the data lines D1, D2 and D3. Then, the emit signal is applied to the emit signal line E1g, and blue, red and green OLED elements OLEDb, OLEDr and OLEDg respectively emit light at three adjacent pixel circuits in the row direction.

When the select signal is applied to the scan line S2, data voltages R, G and B respectively corresponding to red, green, and blue OLED elements OLEDr, OLEDg and OLEDb are respectively applied to the data lines D1, D2 and D3. Then, the emit signal is applied to the emit signal line E2g, and red, green and blue OLED elements OLEDr, OLEDg and OLEDb respectively emit light at three adjacent pixel circuits in the row direction.

When the select signal is applied to the scan line S3, data voltages G, B and R respectively corresponding to green, blue, and red OLED elements OLEDg, OLEDb and OLEDr are respectively applied to the data lines D1, D2 and D3. Then, the emit signal is applied to the emit signal line E3g, and green, blue and red OLED elements OLEDg, OLEDb and OLEDr respectively emit light at three adjacent pixel circuits in the row direction.

Next, in the subfield 3SF, when the select signal is applied to the scan line S1, data voltages G, B and R respectively corresponding to green, blue and red OLED elements OLEDg, OLEDb and OLEDr are respectively applied to the data lines D1, D2 and D3. Then, the emit signal is applied to the emit signal line E1b, and green, blue and red OLED elements OLEDg, OLEDb and OLEDr respectively emit light at three adjacent pixel circuits in the row direction.

When the select signal is applied to the scan line S2, data voltages B, R and G respectively corresponding to blue, red, and green OLED elements OLEDb, OLEDr and OLEDg are respectively applied to the data lines D1, D2 and D3. Then, the emit signal is applied to the emit signal line E2b, and blue, red and green OLED elements OLEDb, OLEDr and OLEDg respectively emit light at three adjacent pixel circuits in the row direction.

When the select signal is applied to the scan line S3, data voltages R, G and B respectively corresponding to red, green, and blue OLED elements OLEDr, OLEDg and OLEDb are respectively applied to the data lines D1, D2 and D3. Then, the emit signal is applied to the emit signal line E3b, and red, green and blue OLED elements OLEDr, OLEDg and OLEDb respectively emit light at three adjacent pixel circuits in the row direction.

As such, three pixel circuits located at same row respectively can display red, green, and blue, and three pixel circuits located at same column respectively can display red, green, and blue in one subfield by driving the pixel circuits formed in the pixel area 220 in the above manner.

In such a manner, the pixel circuits of the plurality of pixel areas included in the display panel can emit mixed three colors of light in the row direction and the column direction at each subfield, and the color separation phenomenon which may be caused because of different colors on the upper region and lower region of the screen is reduced or eliminated.

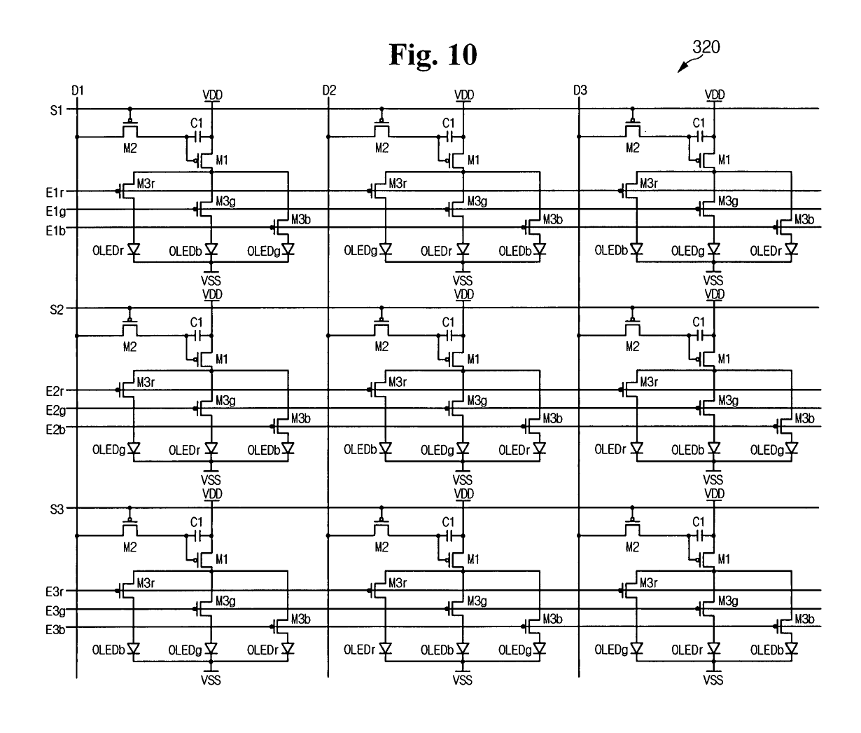

In FIG. 9, the locations of the OLED elements OLEDr, OLEDg and OLEDb are not changed but the emit signal lines are coupled to different emission transistors M3r, M3g and M3b such that the three colors are mixed when the plurality of pixels are emitted. However, the locations of the OLED elements OLEDr, OLEDg and OLEDb may be changed in other embodiments. A third exemplary embodiment of the present invention is described with reference to FIG. 10.

FIG. 10 shows pixel circuits formed in a pixel area 320 according to the third exemplary embodiment. The pixel area 320 is similar to the pixel area 220 of FIGS. 7, 8 and 9 in that the pixel area include 9 pixels in a 3×3 matrix. However, the configuration of each pixel in the pixel area 320 is different from that of the pixel area 220.

As shown in FIG. 10, in the third exemplary embodiment of the present invention, transistors M3r, M3g and M3b of each pixel circuit respectively are coupled to emit signal lines E1r to E3r, E1g to E3g, and E1b to E3b. The transistors M3r, M3g, M3b of pixel circuit in the pixel area 320 respectively are coupled to one color OLED element of three color OLED elements OLEDr, OLEDg, and OLEDb.

In detail, OLED elements OLEDr, OLEDb, OLEDg are arranged in an order of red, blue and green in a pixel circuit coupled to a first row and a first column, OLED elements OLEDg, OLEDr, OLEDb are arranged in an order of green, red and blue in a pixel circuit coupled to a first row and a second column, and OLED elements OLEDb, OLEDg, OLEDr are arranged in an order of blue, green and red in a pixel circuit coupled to a first row and a third column.

Further, OLED elements OLEDg, OLEDr, OLEDb are arranged in an order of green, red and blue in a pixel circuit coupled to a second row and a first column, OLED elements OLEDb, OLEDg, OLEDr are arranged in an order of blue, green and red in a pixel circuit coupled to a second row and a second column, and OLED elements OLEDr, OLEDb, OLEDg are arranged in an order of red, blue and green in a pixel circuit coupled to a second row and a third column.

Further, OLED elements OLEDb, OLEDg, OLEDr are arranged in an order of blue, green and red in a pixel circuit coupled to a third row and a first column, OLED elements OLEDr, OLEDb, OLEDg are arranged in an order of red, blue and green in a pixel circuit coupled to a third row and a second column, and OLED elements OLEDg, OLEDr, OLEDb are arranged in an order of green, red and blue in a pixel circuit coupled to a third row and a third column.

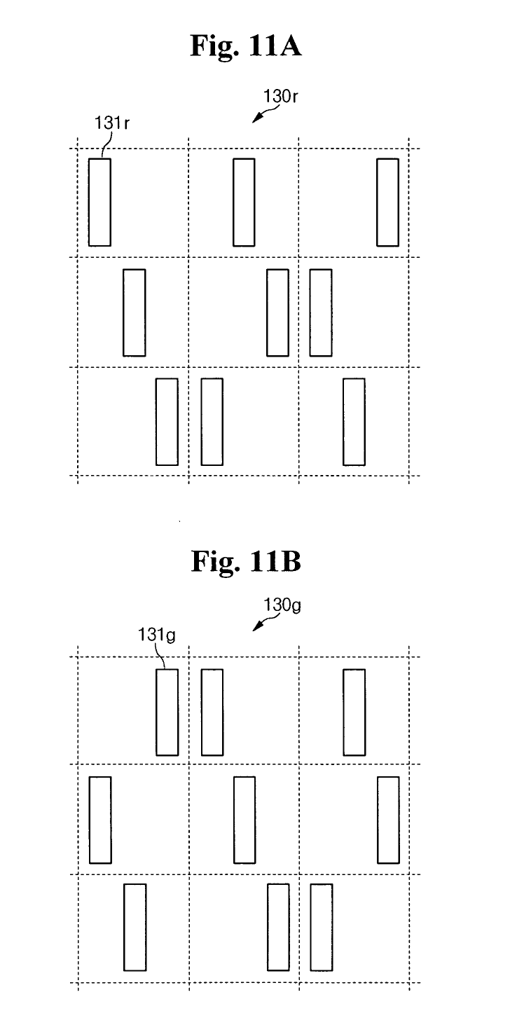

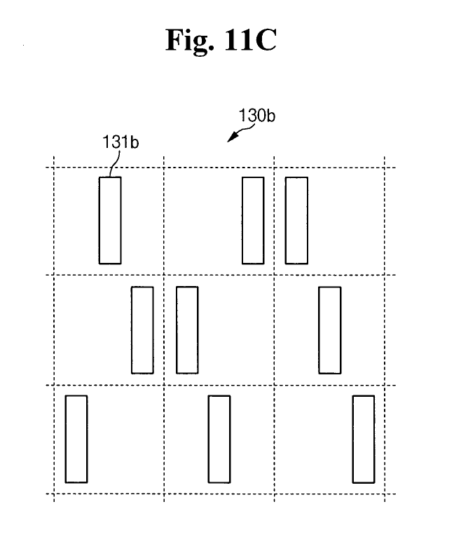

As such, when the pixel circuit is formed by above manner, and the driving waveform for the emission lines of FIG. 6 is applied, substantially the same emission described in reference to the second exemplary embodiment may be made. Next, a deposition mask to form the pixel area described in FIG. 10 is described with a reference to FIGS. 11A, 11B and 11C.

FIG. 11A, FIG. 11B and FIG. 11C respectively show parts of a deposition mask to form red, green and blue OLED elements in a display panel of a light emission display according to a third exemplary embodiment of the present invention. FIG. 11A to FIG. 11C show one pixel area 320 of the deposition mask. The display panel and the pixel area for the pixels of FIGS. 10, 11A, 11B and 11C have substantially the same configuration as the display panel 200 and the pixel area 220 of FIG. 7, but the pixels in the pixel area 320 of FIGS. 10, 11A, 11B and 11C have different configurations from the configurations of the pixels in the pixel area 220 of FIG. 7.

As shown in FIG. 10 and FIG. 11A, a deposition mask 130r for forming a red OLED element OLEDr has an aperture at area corresponding to the red OLED element OLEDr in the pixel area 320. That is, the deposition mask 130r has the aperture 131r at an area corresponding to a red OLED element OLEDr at a first position (i.e., at the left of the three subpixel positions) in a pixel of a first row and a first column, a second row and a third column, and a third row and a second column. In addition, the deposition mask 130r has the aperture 131r at an area corresponding to a red OLED element OLEDr at a second position (i.e., in the middle of the three subpixel positions) in a pixel of a first row and a second column, a second row and a first column, and a third row and a third column. Further, the deposition mask 130r has the aperture 131r at an area corresponding to a red OLED element OLEDr at a third position (i.e., at the right of the three subpixel positions) in a pixel of a first row and a third column, a second row and a second column, and a third row and a first column.

In a like manner, as shown in FIG. 10 and FIG. 11B, a deposition mask 130g for forming a green OLED element OLEDg has an aperture 131g at each area corresponding to the green OLED element OLEDg in the pixel area 320. Further, as shown in FIG. 10 and FIG. 11C, a deposition mask 130b for forming a blue OLED element OLEDb has an aperture 131b at each area corresponding to the green OLED element OLEDb in the pixel area 320.

Further, to form the red OLED element OLEDr in the display panel, the deposition mask 130r is formed on the display panel and an organic matter representing red color is deposited on the display panel to form an organic emission layer for the OLED element OLEDr. In a like manner, to form the green and blue OLED elements OLEDg and OLEDb in the display panel, the deposition masks 130g and 130b respectively are formed on the display panel and organic matters representing green color and blue color are deposited on the display panel to form organic emission layers for the OLED elements OLEDg and OLEDb.

According to the exemplary embodiments of the present invention, the configuration of elements used within the pixels and the wiring design for transmitting the current, voltages, and signals are simplified since the emit elements of various colors on one pixel can be driven by common driving and switching transistors and capacitors, thereby improving the aperture ratio in the pixel. Further, the color separation phenomenon is reduced or eliminated by emitting different colors for the respective rows in one subfield.

While this invention has been described in connection with certain exemplary embodiments, it is to be understood that the invention is not limited to the disclosed embodiments, but, on the contrary, is intended to cover various modifications and equivalent arrangements included within the spirit and scope of the appended claims.

1. A display device having a display area in which a plurality of pixel circuits are formed, wherein
at least one of the pixel circuits comprises:
at least two emit elements for respectively emitting different color lights corresponding to an applied current,
a transistor for providing an output current according to a data signal, and
at least two first switches for respectively applying the output current provided by the transistor as the applied current to the at least two emit elements,
wherein the display area is divided into a plurality of first pixel groups, each comprising some of the pixel circuits, and each of the first pixel groups is divided into a plurality of second pixel groups, each comprising at least one of the pixel circuits,
wherein the plurality of second pixel groups of at least one of the first pixel groups respectively emit different color lights in a first subfield, and the plurality of second pixel groups of the at least one of the first pixel groups respectively emit different color lights in a second subfield, and
wherein the color of light emitted by at least one of the second pixel groups during the first subfield is different from the color of light emitted by the at least one of the second pixel groups during the second subfield.

2. The display device of claim 1, wherein a plurality of scan lines are further formed in the display area, and
wherein the at least one of the pixel circuits further comprises a second switch for transmitting the data signal to the transistor in response to a select signal, and a capacitor for storing a voltage corresponding to the data signal transmitted from the second switch.

3. The display device of claim 1, wherein one of the at least two first switches is turned on in each subfield.

4. The display device of claim 1, wherein a number of the second pixel groups emitting substantially the same color light is the same in at least one of the first pixel groups.

5. The display device of claim 1, wherein the at least two emit elements of the at least one of the pixel circuits respectively emit light at least one time during one field comprising the first and second subfields.

6. The display device of claim 1, wherein the emit elements are differently arranged in the pixel circuits of at least two of the second pixel groups of at least one of the first pixel groups.

7. The display device of claim 1, wherein the at least two emit elements comprise a first color emit element, a second color emit element, and a third color emit element, and
wherein a number of the pixel circuits of at least one of the first pixel groups is a multiple of three.

8. A display panel of a display device comprising:
a display area for displaying an image corresponding to a magnitude of an applied current, in which a plurality of pixel circuits having at least two emit elements for respectively emitting different color images are formed,
wherein a plurality of first areas, each comprising some of the plurality of pixel circuits, are formed in the display area,
wherein a plurality of second areas, each comprising at least one of the pixel circuits, are formed in at least one of the first areas, and
wherein one field is divided into a plurality of subfields and then driven, and the plurality of second areas in the at least one of the first areas are configured to display different color images during one of the subfields.

9. The display panel of a display device of claim 8, wherein at least one of the second areas in another one of the subfields is configured to display an image having a color different from the color displayed during the one of the subfields.

10. The display panel of a display device of claim 8, wherein a number of the second areas emitting substantially the same color image of the plurality of second areas in the at least one of the first areas is the same in the one of the subfields.

11. The display panel of a display device of claim 8, wherein the at least two emit elements respectively emit light at least one time during one field.

12. The display panel of a display device of claim 8, wherein the at least one of the pixel circuits further comprises a capacitor for storing a voltage corresponding to a data signal in response to a select signal, a transistor for outputting a current corresponding to the voltage stored in the capacitor, and at least two first switches respectively coupled between the transistor and the at least two emit elements.

13. The display panel of a display device of claim 12, wherein the display area further comprises a signal line for transmitting a control signal to control at least one of the at least two first switches, and
wherein the at least two first switches apply the current outputted by the transistor to one of the two emit elements in response to the control signal.

14. The display panel of a display device of claim 8, wherein the emit elements are respectively differently arranged at the pixel circuits of two of the second areas in the at least one of the first areas.

15. A driving method of a display device having a display area in which a plurality of pixel circuits are formed,
wherein at least one of the pixel circuits comprises at least two emit elements for respectively emitting different color lights corresponding to an applied current, a capacitor for storing a voltage corresponding to the data signal in response to a select signal, a transistor for providing a current corresponding to the voltage stored in the capacitor as the applied current,
wherein the display area is divided into a plurality of first areas, each comprising some of the pixel circuits, and at least one of the first areas is divided into a plurality of second areas, each comprising at least one of the pixel circuits,
wherein the driving method comprises in one frame,
emitting different color lights in the plurality of second areas in at least one of the first areas during a first stage, and
emitting different color lights in the plurality of second areas in the at least one of the first areas during a second stage,
wherein the color of the light emitted in at least one of the second areas during the first stage is different from the color of the light emitted in the at least one of the second areas during the second stage.

16. The driving method of a display device of claim 15, wherein a number of the second pixel areas emitting substantially the same color light is the same in the first stage.

17. The driving method of a display device of claim 15, wherein the second areas that are adjacent to each other along a row direction of the plurality of the second areas in the at least one of the first areas, display different color lights during the first stage.

18. The driving method of a display device of claim 16, wherein the second areas that are adjacent to each other in a column direction of the plurality of the second areas in the at least one of the first areas display different color lights during the first stage.

19. The driving method of a display device of claim 15, wherein the second areas that are adjacent to each other in a row direction of the plurality of second areas in the at least one of the first areas display different color lights in the second stage, and the second areas that are adjacent to each other in a column direction of the plurality of second areas in the at least one of the first areas display different color lights in the second stage.

20. A deposition mask for forming an emit layer defining a first color of an emit element in a display device in which a display area having a plurality of pixels, each having at least two emit elements having different colors, is formed, the deposition mask comprising:
a plurality of first areas, each of the first areas corresponding to one of a plurality of pixel groups the display area is divided into, wherein at least one of the first areas is divided into a plurality of second areas, each having at least one of the pixels, and
a plurality of apertures which are respectively formed at third areas corresponding to the first color of emit elements of the plurality of pixels,
wherein the third areas are differently arranged in two different ones of the second areas of at least one of the first areas.
